(19) United States
(12) Patent Application Publication
(10) Pub. No.: US 2025/0322514 A1
(43) Pub. Date: Oct. 16, 2025

(54) AUTOMATIC SURGICAL MARKER MOTION DETECTION USING SCENE REPRESENTATIONS FOR VIEW SYNTHESIS

(71) Applicants: Smith & Nephew, Inc., Memphis, TN (US); Smith & Nephew Asia Pacific Pte. Limited, Singapore (SG)

(72) Inventors: Sofia Rebelo DE ALMEIDA MOREIRA, Coimbra (PT); João Pedro DE ALMEIDA BARRETO, Coimbra (PT); Carolina DOS SANTOS RAPOSO, Coimbra (PT); Michel Gonçalves ALMEIDA ANTUNES, Coimbra (PT)

(73) Assignees: Smith & Nephew, Inc., Memphis, TN (US); Smith & Nephew Asia Pacific Pte. Limited, Singapore (SG)

(21) Appl. No.: 19/170,202

(22) Filed: Apr. 4, 2025

Related U.S. Application Data
(60) Provisional application No. 63/632,072, filed on Apr. 10, 2024.

(51) Int. Cl. G06T 7/00; G06T 7/11

(52) U.S. Cl. CPC G06T 7/0012; G06T 7/11; G06T 2207/10016; G06T 2207/10068; G06T 2207/20084; G06T 2207/30008; G06T 2207/30204

(57) ABSTRACT

A movement detection system for a surgical procedure performed in a surgical environment includes memory storing instructions and one or more processing devices configured to execute the instructions. Executing the instructions causes the movement detection system to receive first data corresponding to one or more images of the surgical environment, the one or more images including at least one visual marker located within the surgical environment, using the first data, generate a scene representation corresponding to the one or more images, generate, based on the scene representation and a location of the at least one visual marker in an image feed of the surgical environment, a synthesized image of the surgical environment, calculate an image similarity score indicating a similarity between the synthesized image and the one or more images, and perform one or more actions based on the image similarity score.

### CROSS-REFERENCE TO RELATED APPLICATIONS

This application claims the benefit of U.S. Provisional App. 63/632,072, filed Apr. 10, 2024, the entire contents of which are incorporated herein by reference.

### BACKGROUND

The present disclosure relates surgical navigation systems and methods, and more particularly to surgical navigation systems and methods for performing joint distraction.

### SUMMARY

A movement detection system for a surgical procedure performed in a surgical environment includes memory storing instructions and one or more processing devices configured to execute the instructions. Executing the instructions causes the movement detection system to receive first data corresponding to one or more images of the surgical environment, the one or more images including at least one visual marker located within the surgical environment, using the first data, generate a scene representation corresponding to the one or more images, generate, based on the scene representation and a location of the at least one visual marker in an image feed of the surgical environment, a synthesized image of the surgical environment, calculate an image similarity score indicating a similarity between the synthesized image and the one or more images, and perform one or more actions based on the image similarity score.

In other features, generating the synthesized image includes generating a plurality of synthesized images corresponding to a plurality of locations of the at least one visual marker. Generating the synthesized image includes using, to generate the synthesized imaged, at least one of a neural radiance field (NeRF) model, neutral representation modeling, light field sampling, mesh-based representation, a differentiable rasterizer, and Gaussian splatting. Calculating the image similarity score includes calculating a peak signal-to-noise ratio based on a comparison between the synthesized image and the one or more images. Performing the one or more actions includes correcting alignment data associated with the at least one visual marker based on the image similarity score.

In other features, performing the one or more actions includes determining whether the image similarity score is less than a detection threshold and performing the one or more actions in response to the image similarity score being less than the detection threshold. An image similarity score less than the detection threshold is indicative of movement of the at least one visual marker. The image feed includes intra-operative arthroscopic images. The at least one visual marker includes a fiducial marker fixed to patient anatomy. Generating the scene representation includes generating the scene using a neural radiance field (NeRF) model and generating the synthesized image includes generating the synthesized image using the NeRF model.

A method for detecting movement of at least one visual marker within a surgical environment includes, using one or more processing devices, receiving first data corresponding to one or more images of the surgical environment, the one or more images including at least one visual marker located within the surgical environment using the first data, generating a scene representation corresponding to the one or more images, generating, based on the scene representation and a location of the at least one visual marker in an image feed of the surgical environment, a synthesized image of the surgical environment, calculating an image similarity score indicating a similarity between the synthesized image and the one or more images, and performing one or more actions based on the image similarity score.

In other features, generating the synthesized image includes generating a plurality of synthesized images corresponding to a plurality of locations of the at least one visual marker. Generating the synthesized image includes using, to generate the synthesized image, at least one of a neural radiance field (NeRF) model, neutral representation modeling, light field sampling, mesh-based representation, a differentiable rasterizer, and Gaussian splatting. Calculating the image similarity score includes calculating a peak signal-to-noise ratio based on a comparison between the synthesized image and the one or more images. Performing the one or more actions includes correcting alignment data associated with the at least one visual marker based on the image similarity score.

In other features, performing the one or more actions includes determining whether the image similarity score is less than a detection threshold and performing the one or more actions in response to the image similarity score being less than the detection threshold. An image similarity score less than the detection threshold is indicative of movement of the at least one visual marker. The image feed includes intra-operative arthroscopic images. The at least one visual marker includes a fiducial marker fixed to patient anatomy. Generating the scene representation includes generating the scene using a neural radiance field (NeRF) model and generating the synthesized image includes generating the synthesized image using the NeRF model.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

For a detailed description of example embodiments, reference will now be made to the accompanying drawings in which:

FIG. 1 shows a surgical system in accordance with at least some embodiments;

FIG. 2 shows a conceptual drawing of a surgical site with various objects within the surgical site tracked, in accordance with at least some embodiments;

FIG. 3 shows a method in accordance with at least some embodiments;

FIG. 4 is an example video display showing portions of a femur and a bone fiducial during a registration procedure, in accordance with at least some embodiments;

FIG. 5 shows a method in accordance with at least some embodiments;

FIGS. 6A, 6B, and 6C illustrate results of example marker movement detection techniques in accordance with at least some embodiments;

FIG. 7 FIG. 7 shows example image similarity metrics in accordance with at least some embodiments;

FIG. 8 shows an example method for performing marker movement detection techniques in accordance with at least some embodiments; and

FIG. 9 shows an example computer system or computing device configured to implement the various systems and methods of the present disclosure.

In the drawings, reference numbers may be reused to identify similar and/or identical elements.

### DEFINITIONS

Various terms are used to refer to particular system components. Different companies may refer to a component by different names-this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

Similarly, spatial and functional relationships between elements (for example, between device, modules, circuit elements, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. Nevertheless, this paragraph shall serve as antecedent basis in the claims for referencing any electrical connection as “directly coupled” for electrical connections shown in the drawing with no intervening element(s).

Terms of degree, such as “substantially” or “approximately,” are understood by those skilled in the art to refer to reasonable ranges around and including the given value and ranges outside the given value, for example, general tolerances associated with manufacturing, assembly, and use of the embodiments. The term “substantially,” when referring to a structure or characteristic, includes the characteristic that is mostly or entirely present in the characteristic or structure. As one example, numerical values that are described as “approximate” or “approximately” as used herein may refer to a value within +/−5% of the stated value.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions. To be clear, an initial reference to “a [referent]”, and then a later reference for antecedent basis purposes to “the [referent]”, shall not obviate the fact the recited referent may be plural.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. As used herein, the phrase at least one of A, B, and C should be construed to mean a logical (A OR B OR C), using a non-exclusive logical OR, and should not be construed to mean “at least one of A, at least one of B, and at least one of C.”

The terms “input” and “output” when used as nouns refer to connections (e.g., electrical, software) and/or signals, and shall not be read as verbs requiring action. For example, a timer circuit may define a clock output. The example timer circuit may create or drive a clock signal on the clock output. In systems implemented directly in hardware (e.g., on a semiconductor substrate), these “inputs” and “outputs” define electrical connections and/or signals transmitted or received by those connections. In systems implemented in software, these “inputs” and “outputs” define parameters read by or written by, respectively, the instructions implementing the function. In examples where used in the context of user input, “input” may refer to actions of a user, interactions with input devices or interfaces by the user, etc.

“Controller,” “module,” or “circuitry” shall mean, alone or in combination, individual circuit components, an application specific integrated circuit (ASIC), a microcontroller with controlling software, a reduced-instruction-set computer (RISC) with controlling software, a digital signal processor (DSP), a processor with controlling software, a programmable logic device (PLD), a field programmable gate array (FPGA), or a programmable system-on-a-chip (PSOC), configured to read inputs and drive outputs responsive to the inputs.

As used to describe various surgical instruments or devices, such as a probe, the term “proximal” refers to a point or direction nearest a handle of the probe (e.g., a direction opposite the probe tip). Conversely, the term “distal” refers to a point or direction nearest the probe tip (e.g., a direction opposite the handle).

For the purposes of this disclosure, a non-transitory computer readable medium (or computer-readable storage medium/media) stores computer data, which data can include computer program code (or computer-executable instructions) that is executable by a computer, in machine-readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure, the term “server” should be understood to refer to a service point that provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example. In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device, referred to as user equipment (UE)), may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

In some embodiments, as discussed below, the client device can also be, or can communicatively be coupled to, any type of known or to be known medical device (e.g., any type of Class I, Il or III medical device), such as, but not limited to, a MRI machine, CT scanner, Electrocardiogram (ECG or EKG) device, photopletismograph (PPG), Doppler and transmit-time flow meter, laser Doppler, an endoscopic device neuromodulation device, a neurostimulation device, and the like, or some combination thereof.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

Computer-Aided Surgery (CAS) and surgical navigation systems support surgeons in planning and performing complex surgical procedures with increased precision and accuracy. As one example surgical procedure, arthroscopy is a minimally invasive medical procedure for diagnosing and treating joint problems. An orthopedic surgeon makes a small incision in the skin of the patient and inserts a lens into the incision. The lens is attached to a camera and coupled to a light source, allowing the joint to be visualized and treated. Surgical navigation and CAS systems have had significant impact in minimally invasive surgeries (MIS) such as arthroscopic procedures because the increased difficulty in visualizing the anatomy of the patient further complicates the surgical workflow.

Video-based surgical navigation leverages visual fiducials or markers (also called visual markers attached to patient anatomy to guide the surgeon throughout the medical procedure. The video-based navigation process requires the precise registration of a pre-operative anatomical model with data acquired intra-operatively. The registration process requires the surgeon to digitize the surface of interest that corresponds to the pre-operative model. The visual markers attached to the anatomies define reference frames to which the pre-operative model and the intra-operative acquired data are aligned. After fixation, motion of these visual markers may occur when arthroscopes, endoscopes, or surgical instruments collide with the visual markers. Marker motion after the registration process may cause a misalignment of the anatomies with the pre-operative model and previously acquired data and therefore may compromise the surgical navigation by providing incorrect guidance and support to the surgeon. Accordingly, detection of motion of the visual markers after the registration process is critical. If detected in a timely manner, the registration process can be re-performed or automatically corrected and surgical navigation can be resumed.

Marker movement detection systems and methods according to the principles of the present disclosure are configured to detect movement/displacement of visual markers (e.g., fiducial markers) fixed to anatomic surfaces (e.g., movement caused by collision with instruments, such as an endoscope). For example, video-based surgical navigation techniques use fiducials or other markers attached to patient anatomy to guide a surgeon throughout a medical procedure. The markers define reference frames to which the pre-operative model and the intra-operative acquired data can be aligned. However, subsequent movement of markers may cause a misalignment between the anatomies and the pre-operative model and previously acquired data. Accordingly, it is critical to detect any movement of the markers (e.g., movement subsequent to a registration process). If detected in a timely manner, the registration process can be repeated or adjusted, and surgical navigation can then be resumed.

Some conventional techniques for detecting movement of markers may include augmented reality (AR) techniques. For example, by projecting a registered pre-operative 3D model onto images being acquired intra-operatively (e.g., by the arthroscopic camera), alignment can be continuously monitored. If the visual markers move subsequent to the registration process, then the overlay of the AR becomes misaligned with the intra-operative video. The main drawback of this approach is that it is not automatic, requiring a user to inspect the overlay of the AR visually and continuously with the intra-operative video. In addition, small movements are very difficult to detect visually in the operating room.

Accordingly, marker movement detection systems and methods according to the present disclosure are configured to automatically detect movement of visual markers fixed to anatomic surfaces using synthetic view synthesis techniques. Generally, these techniques include:
1) Acquiring a sparse or dense set of images of the surgical environment including the visual markers;
2) Using the images to generate a scene representation (e.g., a scene representation of a “real” image), enabling the creation of synthetic images from positions of the visual markers; and
3) For each new visual marker location in an image feed, generate a new synthetic/synthesized image.

If the new visual marker location is consistent with marker location used during the computation of the scene representation (e.g., as indicated by an image similarity calculation or algorithm), then the real and synthetic/synthesized images should be similar. Conversely, if the visual marker moved subsequent to the generation of the scene representation, then the synthesized image will differ from the real image.

As one example, neural radiance field (NeRF) techniques can be used to generate the synthesized images. NeRF techniques allow new views to be synthesized by directly optimizing parameters of a continuous 5D representation to minimize the error of rendering/synthesizing a set of input images. For example, to develop a NeRF model, images and the corresponding camera poses are required during the training process, which can be obtained from visual markers using various video-based surgical navigation techniques.

While described with respect to NeRF techniques, the principles of the present disclosure can be implemented using other techniques for generating synthetic images. Example techniques may include, but are not limited to: neutral representation modeling techniques; light field sampling techniques; mesh-based representation techniques; differentiable rasterizer techniques; and/or Gaussian splatting techniques.

Image similarity can be calculated using various methods. For example, photometric errors can be used for quantitative comparisons purposes. As one example, a Peak Signal-to-Noise Ratio (PSNR) is a quantitative measurement of similarity between an original image (the ground-truth) and a corresponding rendered (synthetic) image. The higher the PSNR, the greater the similarity of the rendered image to the original image.

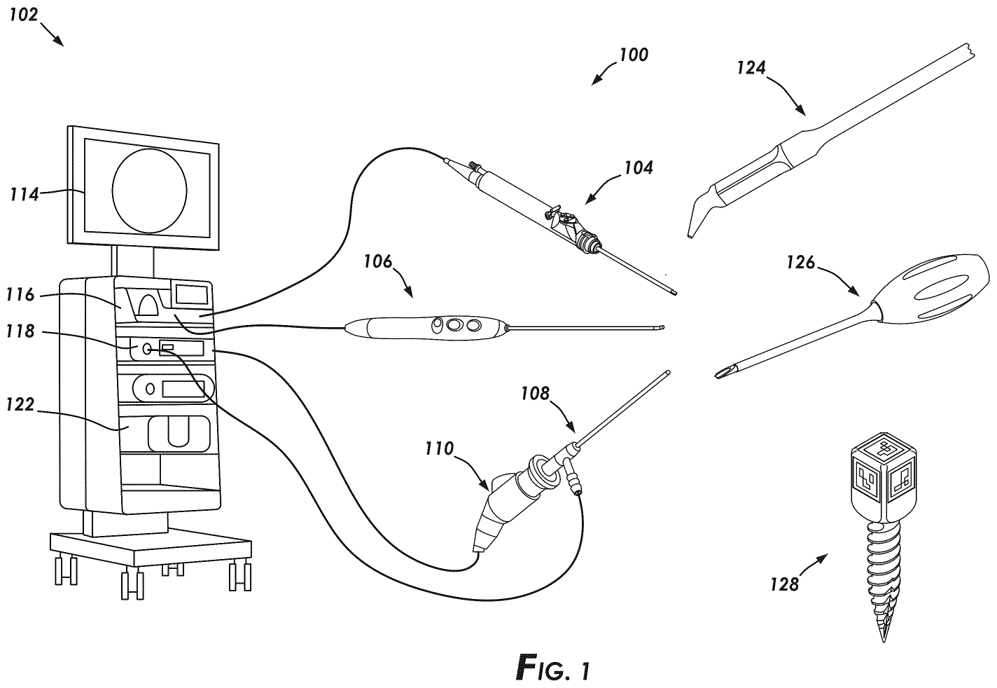

FIG. 1 shows an example surgical system (e.g., a system including or implementing an arthroscopic video-based navigation system) 100 in accordance with at least some embodiments of the present disclosure. In particular, the example surgical system 100 comprises a tower or device cart 102 and various tools or instruments, such as an example mechanical resection instrument 104, an example plasma-based ablation instrument (hereafter just ablation instrument 106), and an endoscope in the example form of an arthroscope 108 and attached camera head or camera 110. In the example systems, the arthroscope 108 may be a rigid device, unlike endoscopes for other procedures, such as upper-endoscopies. The device cart 102 may comprise a display device 114, a resection controller 116, and a camera control unit (CCU) together with an endoscopic light source and video (e.g., a VBN) controller 118. In example cases the combined CCU and video controller 118 not only provides light to the arthroscope 108 and displays images received from the camera 110, but also implements various additional aspects, such as registering a three-dimensional bone model with the bone visible in the video images, and providing computer-assisted navigation during the surgery. Thus, the combined CCU and video controller are hereafter referred to as surgical controller 118. In other cases, however, the CCU and video controller may be a separate and distinct system from the controller that handles registration and computer-assisted navigation, yet the separate devices would nevertheless be operationally coupled.

The example device cart 102 further includes a pump controller 122 (e.g., single or dual peristaltic pump). Fluidic connections of the mechanical resection instrument 104 and ablation instrument 106 to the pump controller 122 are not shown so as not to unduly complicate the figure. Similarly, fluidic connections between the pump controller 122 and the patient are not shown so as not to unduly complicate the figure. In the example system, both the mechanical resection instrument 104 and the ablation instrument 106 are coupled to the resection controller 116 being a dual-function controller. In other cases, however, there may be a mechanical resection controller separate and distinct from an ablation controller. The example devices and controllers associated with the device cart 102 are merely examples, and other examples include vacuum pumps, patient-positioning systems, robotic arms holding various instruments, ultrasonic cutting devices and related controllers, patient-positioning controllers, and robotic surgical systems.

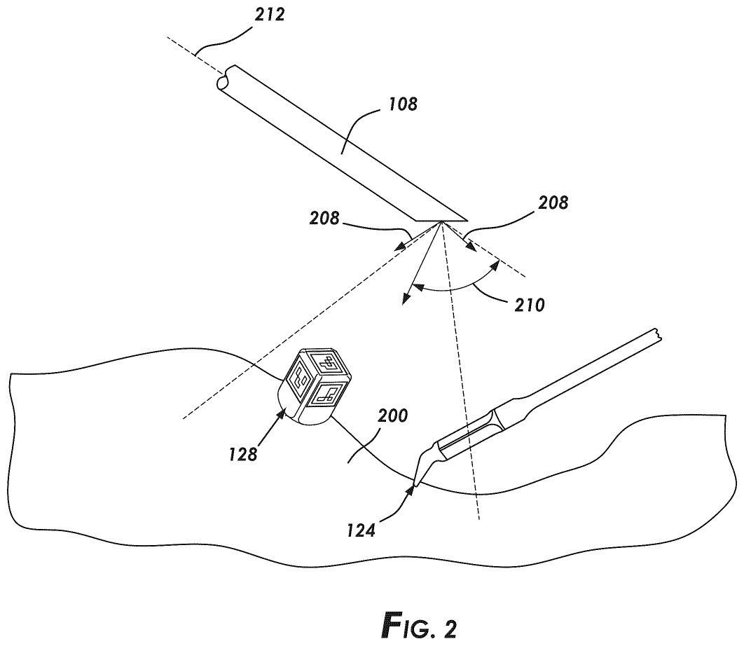

FIGS. 1 and 2 further show additional instruments that may be present during an arthroscopic surgical procedure. In particular, an example probe 124 (e.g., shown as a touch probe, but which may be a touchless probe in other examples), a drill guide or aimer 126, and a bone fiducial 128 are shown. The probe 124 may be used during the surgical procedure to provide information to the surgical controller 118, such as information to register a three-dimensional bone model to an underlying bone visible in images captured by the arthroscope 108 and camera head 110. In some surgical procedures, the aimer 126 may be used as a guide for placement and drilling with a drill wire to create an initial or pilot tunnel through the bone. The bone fiducial 128 may be affixed or rigidly attached to the bone and serve as an anchor location for the surgical controller 118 to know the orientation of the bone (e.g., after registration of a three-dimensional bone model). Additional tools and instruments may be present, such as the drill wire, various reamers for creating the throughbore and counterbore aspects of a tunnel through the bone, and various tools, such as for suturing and anchoring a graft. These additional tools and instruments are not shown so as not to further complicate the figure.

Example workflow for a surgical procedure is described below. While described with respect to an example anterior cruciate ligament repair procedure, the below techniques may also be performed for other types of surgical procedures, such as hip procedures or other procedures that include joint distraction. A surgical procedure may begin with a planning phase. An example procedure may start with imaging (e.g., X-ray imaging, computed tomography (CT), magnetic resonance imaging (MRI)) of the anatomy of the patient, including the relevant anatomy (e.g., for a knee procedure the lower portion of the femur, the upper portion of the tibia, and the articular cartilage; for a hip procedure, an upper portion of the femur, the acetabulum/hip joint, pelvis, etc.). The imaging may be preoperative imaging, hours or days before the intraoperative repair, or the imaging may take place within the surgical setting just prior to the intraoperative repair. The discussion that follows assumes MRI imaging, but again many different types of imaging may be used. The image slices from the MRI imaging can be segmented such that a volumetric model or three-dimensional model of the anatomy is created. Any suitable currently available, or after developed, segmentation technology may be used to create the three-dimensional model. More specifically to the example of anterior cruciate ligament repair, a three-dimensional bone model of the lower portion of the femur, including the femoral condyles, is created. Conversely, for a hip procedure, a three-dimensional model of the upper portion of the femur and at least a portion of the pelvis (e.g., the acetabulum) is created.

Using the three-dimensional bone model, an operative plan is created. For a knee procedure, the results of the planning may include: a three-dimensional bone model of the distal end of the femur; a three-dimensional bone model for a proximal end of the tibia; an entry location and exit location through the femur and thus a planned-tunnel path for the femur; and an entry location and exit location through the tibia and thus a planned-tunnel path through the tibia. Other surgical parameters may also be selected during the planning, such as tunnel throughbore diameters, tunnel counterbore diameters and depth, desired post-repair flexion, and the like, but those additional surgical parameters are omitted so as not to unduly complicate the specification.

Conversely, for a hip procedure, the results of the planning may include a three-dimensional bone model of the proximal end of the femur; a three-dimensional bone model for at least a portion of the pelvis/hip joint (e.g., a region of the pelvis corresponding to the acetabulum); a surgical area of interest within the hip joint; and parameters associated with achieving an amount of distraction in the surgical area of interest to provide sufficient access to the surgical area of interest. For example, example hip procedures may include, but are not limited to, labral repair, femoroacetabular impingement (FAI) debridement (e.g., removal of bone spurs/growths), cartilage repair, and synovectomy (e.g., removal of inflamed tissue). These example procedures typically require access to a specific surgical area of interest within the hip joint (i.e., in a specific area within an interface between the pelvis and the femoral head, such as an area around/surrounding a bone spur or growth, cartilage or tissue to be repaired or removed, etc.). Accordingly, the parameters may include ranges of values, minimum and/or maximum values, etc. required/recommended for providing access to the surgical area of interest within the hip joint. As one example, the parameters may include a minimum amount of distraction (e.g., a minimum space or gap) in an area around, centered on, etc. the surgical area of interest (e.g., a minimum gap at one or more entry/access points, for a surgical instrument, around a bone spur, bump or other anatomical feature associated with the surgical procedure).

The intraoperative aspects include steps and procedures for setting up the surgical system to perform the various repairs. It is noted, however, that some of the intraoperative aspects (e.g., optical system calibration) may take place before any ports or incisions are made through the patient's skin, and in fact before the patient is wheeled into the surgical room. Nevertheless, such steps and procedures may be considered intraoperative as they take place in the surgical setting and with the surgical equipment and instruments used to perform the actual repair.

An example procedure can be conducted arthroscopically and is computer-assisted in the sense that the surgical controller 118 is used for arthroscopic navigation within the surgical site. More particularly, in example systems the surgical controller 118 provides computer-assisted navigation during the procedure by tracking locations of various objects within the surgical site, such as the location of the bone within the three-dimensional coordinate space of the view of the arthroscope, and location of the various instruments within the three-dimensional coordinate space of the view of the arthroscope. A brief description of such tracking techniques is described below.

FIG. 2 shows a conceptual drawing of a surgical site with various objects (e.g., surgical instruments/tools) within the surgical site. In particular, visible in FIG. 2 is a distal end of the arthroscope 108, a portion of a bone 200 (e.g., femur), the bone fiducial 128 within the surgical site, and the probe 124.

The arthroscope 108 illuminates the surgical site with visible light. In the example of FIG. 2, the illumination is illustrated by arrows 208. The illumination provided to the surgical site is reflected by various objects and tissues within the surgical site, and the reflected light that returns to the distal end enters the arthroscope 108, propagates along an optical channel within the arthroscope 108, and is eventually incident upon a capture array within the camera 110 (FIG. 1). The images detected by the capture array within the camera 110 are sent electronically to the surgical controller 118 (FIG. 1) and displayed on the display device 114 (FIG. 1). In one example, the arthroscope 108 is monocular or has a single optical path through the arthroscope for capturing images of the surgical site, notwithstanding that the single optical path may be constructed of two or more optical members (e.g., glass rods, optical fibers). That is to say, in example systems and methods the computer-assisted navigation provided by the arthroscope 108, the camera 110, and the surgical controller 118 is provided with the arthroscope 108 that is not a stereoscopic endoscope having two distinct optical paths separated by an interocular distance at the distal end endoscope.

During a surgical procedure, a surgeon selects an arthroscope with a viewing direction beneficial for the planned surgical procedure. Viewing direction refers to a line residing at the center of an angle subtended by the outside edges or peripheral edges of the view of an endoscope. The viewing direction for some arthroscopes is aligned with the longitudinal central axis of the arthroscope, and such arthroscopes are referred to as “zero degree” arthroscopes (e.g., the angle between the viewing direction and the longitudinal central axis of the arthroscope is zero degrees). The viewing direction of other arthroscopes forms a non-zero angle with the longitudinal central axis of the arthroscope. For example, for a 30° arthroscope the viewing direction forms a 30° angle to the longitudinal central axis of the arthroscope, the angle measured as an obtuse angle beyond the distal end of the arthroscope. In the example of FIG. 2, the view angle 210 of the arthroscope 108 forms a non-zero angle to the longitudinal central axis 212 of the arthroscope 108.

Still referring to FIG. 2, within the view of the arthroscope 108 is a portion of the bone 200 (in this example, within the intercondylar notch), along with the example bone fiducial 128, and the example probe 124. The example bone fiducial 128 is multi-faceted element, with each face or facet having a fiducial disposed or created thereon. However, the bone fiducial need not have multiple faces, and in fact may take any shape so long as that shape can be tracked within the video images. The bone fiducial, such as bone fiducial 128, may be attached to the bone 200 in any suitable form (e.g., via the screw portion of the bone fiducial 128 visible in FIG. 1). The patterns of the fiducials on each facet are designed to provide information regarding the orientation of the bone fiducial 128 in the three-dimensional coordinate space of the view of the arthroscope 108. More particularly, the pattern is selected such that the orientation of the bone fiducial 128 may be determined from images captured by the arthroscope 108 and attached camera (FIG. 1).

The probe 124 is also shown as partially visible within the view of the arthroscope 108. The probe 124 may be used, as discussed more below, to identify a plurality of surface features on the bone 200 as part of the registration of the bone 200 to the three-dimensional bone model. Alternatively, though not specifically shown, the aimer 126 (FIG. 1) may be used as the device to help with the registration process. In some cases the probe 124 and/or the aimer 126 may carry their own, unique fiducials, such that their respective poses may be calculated from the one or more fiducial present in the video stream. However, in other cases, and as shown, the medical instrument used to help with registration of the three-dimensional bone model, be it the probe 124, the aimer 126, or any other suitable medical device, may omit carrying fiducials. Stated otherwise, in such examples the medical instrument has no fiducial markings. In such cases, the pose of the medical instrument may be determined by a machine learning model, discussed in more detail below.

The images captured by the arthroscope 108 and attached camera are subject to optical distortion in many forms. For example, the visual field between distal end of the arthroscope 108 and the bone 200 within the surgical site is filled with fluid, such as bodily fluids and saline used to distend the joint. Many arthroscopes have one or more lenses at the distal end that widen the field of view, and the wider field of view causes a “fish eye” effect in the captured images. Further, the optical elements within the arthroscope (e.g., rod lenses) may have optical aberrations inherent to the manufacturing and/or assembly process. Further still, the camera may have various optical elements for focusing the images received onto the capture array, and the various optical elements may have aberrations inherent to the manufacturing and/or assembly process. In example systems, prior to use within each surgical procedure, the endoscopic optical system is calibrated to account for the various optical distortions. The calibration creates a characterization function that characterizes the optical distortion, and further analysis of the frames of the video stream may be, prior to further analysis, compensated using the characterization function.

The next example step in the intraoperative procedure is the registration of the bone model created during the planning stage. During the intraoperative repair, the three-dimensional bone model is obtained by or provided to the surgical controller 118. Again using the example of anterior cruciate ligament repair, and specifically computer-assisted navigation for tunnel paths through the femur, the three-dimensional bone model of the lower portion of the femur is obtained by or provided to the surgical controller 118. Thus, the surgical controller 118 receives the three-dimensional bone model, and assuming the arthroscope 108 is inserted into the knee by way of a port through the patient's skin, the surgical controller 118 also receives video images of a portion of the lower end of the femur. In order to relate the three-dimensional bone model to the images received by way of the arthroscope 108 and camera 110, the surgical controller 118 registers the three-dimensional bone model to the images of the femur received by way of the arthroscope 108 and camera 110.

In order to perform the registration, and in accordance with example methods, the bone fiducial 128 is attached to the femur. The bone fiducial placement is such that the bone fiducial is within the field of view of the arthroscope 108. In examples for knee procedures, the bone fiducial 128 is placed within the intercondylar notch superior to the expected location of the tunnel through lateral condyle. Conversely, in examples for hip procedures, the bone fiducial 128 is placed on the femoral head. To relate or register bone visible in the video images to the three-dimensional bone model, the surgical controller 118 (FIG. 1) is provided or determines a plurality of surface features of an outer surface of the bone. Identifying the surface features may take several forms, including a touch-based registration using the probe 124 without a carried fiducial, a touchless registration technique in which the surface features are identified after resolving the motion of the arthroscope 108 and camera relative to the bone fiducial 128, and a third technique in which uses a patient-specific instrument.

In the example touch-based registration, the surgeon may touch a plurality of locations using the probe 124 (FIG. 1). In some cases, particularly when portions of the outer surface of the bone are exposed to view, receiving the plurality of surface features of the outer surface of the bone may involve the surgeon “painting” the outer surface of the bone. “Painting” is a term of art that does not involve application of color or pigment, but instead implies motion of the probe 124 when the distal end of the probe 124 is touching bone. In this example, the probe 124 does not carry or have a fiducial visible to the arthroscope 108 and the camera 110. It follows that the pose of the probe 124 and the location of the distal tip of the probe 124 needs to be determined in order to gather the surface features for purposes of registering the three-dimensional bone model.

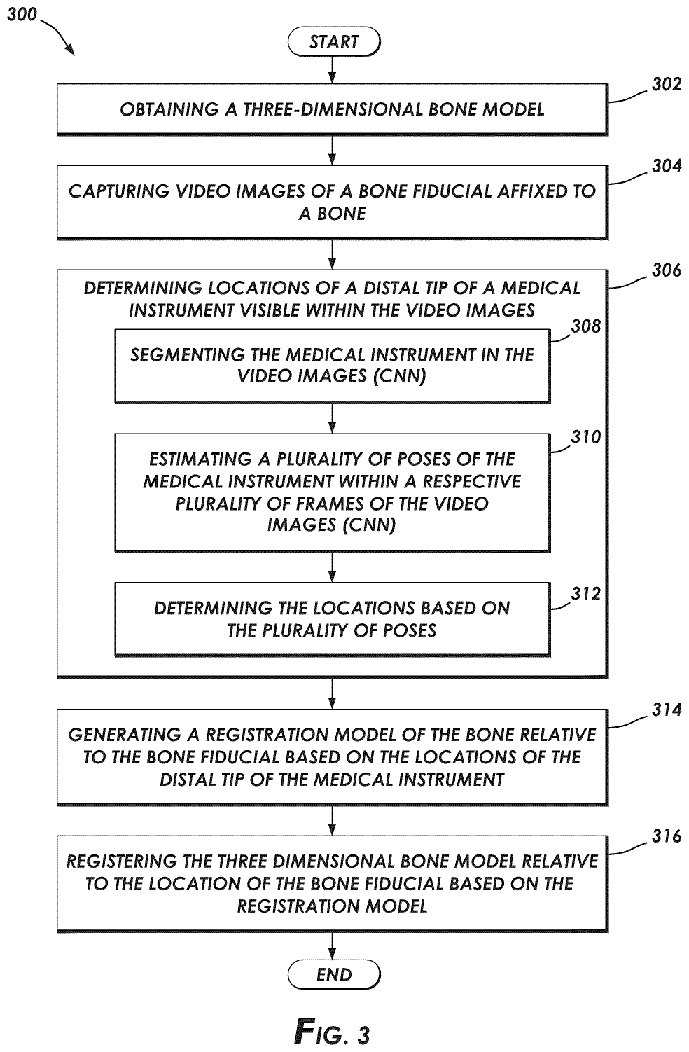

FIG. 3 shows a method 300 in accordance with at least some embodiments of the present disclosure. The example method 300 may be implemented in software within a computer system, such as the surgical controller 118. In particular, the example method 300 comprises obtaining a three-dimensional bone model (block 302). That is to say, in the example method 300, what is obtained is the three-dimensional bone model that may be created by segmenting a plurality of non-invasive images (e.g., CT, MRI) taken preoperatively or intraoperatively. With the bone segmented from or within the images, the three-dimensional bone model may be created. The three-dimensional bone may take any suitable form, such as a computer-aided design (CAD) model, a point cloud of data points with respect to an arbitrary origin, or a parametric representation of a surface expressed using analytical mathematical equations. Thus, the three-dimensional bone model is defined with respect to the origin and in any suitable an orthogonal basis.

The next step in the example method 300 is capturing video images of the bone fiducial attached to the bone (block 304). The capturing is performed intraoperatively. In an example, the capturing of video images is by way of the arthroscope 108 and camera 110. Other endoscopes may be used, such as endoscopes in which the capture array resides at the distal end of the device (e.g., chip-on-the-tip devices). However, in open procedures where the skin is cut and pulled away, exposing the bone to the open air, the capturing may be by any suitable camera device, such as one or both cameras of a stereoscopic camera system, or a portable computing device, such as a tablet or smart-phone device. The video images may be provided to the surgical controller 118 in any suitable form.

The next step in the example method 300 is determining locations of a distal tip of the medical instrument visible within the video images (block 306), where the distal tip is touching the bone in at least some of the frames of the video images, and the medical instrument does not have a fiducial. Determining the locations of the distal tip of the medical instrument may take any suitable form. In one example, determining the locations may include segmenting the medical instrument in the frames of the video images (block 308). The segmenting may take any suitable form, such as applying the video images to a segmentation machine learning algorithm. The segmentation machine learning algorithm may take any suitable form, such as neural network or convolution neural network trained with a training data set showing the medical instrument in a plurality of known orientations. The segmentation machine learning algorithm may produce segmented video images where the medical instrument is identified or highlighted in some way (e.g., box, brightness increased, other objects removed).

With the segmented video images, the example method 300 may estimate a plurality of poses of the medical instrument within a respective plurality of frames of the video images (block 310). The estimating the poses may take any suitable form, such as applying the video images to a pose machine learning algorithm. The pose machine learning algorithm may take any suitable form, such as neural network or convolution neural network trained to perform six-dimensional pose estimation. The resultant of the pose machine learning algorithm may be, for at least some of the frames of the video image, an estimated pose of the medical instrument in the reference frame of the video images and/or in the reference frame provided by the bone fiducial. That is, the resultant of the pose machine learning algorithm may be a plurality of poses, one pose each for at least some of the frames of the segmented video images. While in many cases a pose may be determined for each frame, in other cases it may not be possible to make a pose estimation for at least some frame because of video quality issues, such as motion blur caused by electronic shutter operation.

The next step in the example method 300 is determining the locations based on the plurality of poses (block 312). In particular, for each frame for which a pose can be estimated, based on a model of the medical device the location of the distal tip can be determined in the reference frame of the video images and/or the bone fiducial. Thus, the resultant is a set of locations that, at least some of which, represent locations of the outer surface of the bone.

FIG. 3 shows an example three-step process for determining the locations of the distal tip of the medial instrument. However, the method 300 is merely an example, and many variations are possible. For example, a single machine learning model, such as a convolution neural network, may be set up and trained to perform all three steps as a single overall process, though there may be many hidden layers of the convolution neural network. That is, the convolution neural network may segment the medical instrument, perform the six-dimensional pose estimation, and determine the location of the distal tip in each frame. The training data set in such a situation would include a data set in which each frame has the medical device segmented, the six-dimensional pose identified, and the location of the distal tip identified. The output of the determining step 306 may be a segmented video stream distinct from the video images captured at step 304. In such cases, the later method steps may use both segmented video stream and the video images to perform the further tasks. In other cases, the location information may be combined with the video images, such as being embedded in the video images, or added as metadata to each frame of the video images.

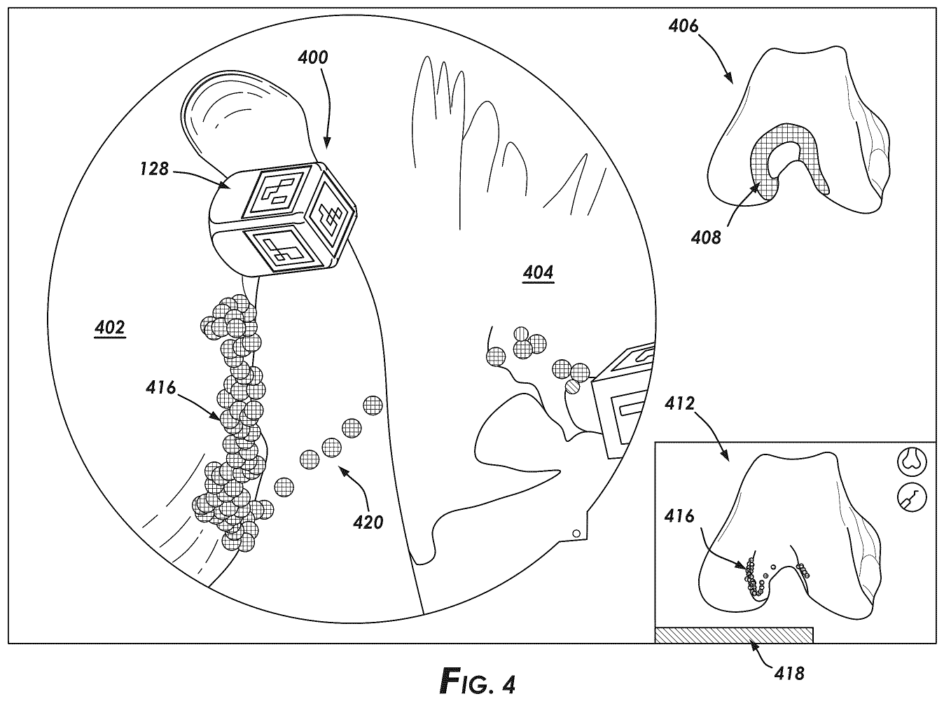

FIG. 4 is an example video display showing portions of a femur and a bone fiducial during a registration procedure. Although described with respect to a distal end of a femur, the principles and techniques described and shown in FIG. 4 can be applied to other anatomical structures/procedures, such as a femoral head for hip procedures as described herein. The display may be shown, for example, on the display device 114 associated with the device cart 102, or any other suitable location. In particular, visible in the main part of the display of FIG. 4 is an intercondylar notch 400, a portion of the lateral condyle 402, a portion the medial condyle 404, and the example bone fiducial 128. Shown in the upper right corner of the example display is a depiction of the bone, which may be a rendering 406 of the bone created from the three-dimensional bone model. Shown on the rendering 406 is a recommended area 408, the recommended area 408 being portions of the surface of the bone to be “painted” as part of the registration process. Shown in the lower right corner of the example display is a depiction of the bone, which again may be a rendering 412 of the bone created from the three-dimensional bone model. Shown on the rendering 412 are a plurality of surface features 416 on the bone model that have been identified as part of the registration process. Further shown in the lower right corner of the example display is progress indicator 418, showing the progress of providing and receiving of locations on the bone. The example progress indicator 418 is a horizontal bar having a length that is proportional to the number of locations received, but any suitable graphic or numerical display showing progress may be used (e.g., 0% to 100%).

Referring to both the main display and the lower right rendering, as the surgeon touches the outer surface of the bone within the images captured by the arthroscope 108 and camera 110, the surgical controller 118 receives the surface features on the bone, and may display each location both within the main display as dots or locations 416, and within the rendering shown in the lower right corner. More specifically, the example surgical controller 118 overlays indications of identified surface features 416 on the display of the images captured by the arthroscope 108 and camera 110, and in the example case shown, also overlays indications of identified surface features 416 on the rendering 412 of the bone model. Moreover, as the number of identified locations 416 increases, the surgical controller 118 also updates the progress indicator 418.

Still referring to FIG. 4, in spite of the diligence of the surgeon, not all locations identified by the surgical controller 118 based on the surgeon's movement of the probe 124 result in valid locations on the surface of the bone. In the example of FIG. 4, as the surgeon moves the probe 124 from the inside surface of the lateral condyle 102 to the inside surface of the medial condyle 104, the surgical controller 118, based on the example six-dimensional pose estimation, receives several locations 420 that likely represent locations at which the distal end of the probe 124 was not in contact with the bone.

With reference to FIG. 3, the plurality of surface features 416 may be, or the example surgical controller 118 may generate, a registration model relative to the bone fiducial 128 (block 314). The registration model may take any suitable form, such as a computer-aided design (CAD) model or point cloud of data points in any suitable orthogonal basis. The registration model, regardless of the form, may have fewer overall data points or less “structure” than the bone model created by the non-invasive computer imaging (e.g., MRI). However, the goal of the registration model is to provide the basis for the coordinate transforms and scaling used to correlate the bone model to the registration model and relative to the bone fiducial 128. Thus, the next step in the example method 300 is registering the bone model relative to the location of the bone fiducial based on the registration model (block 316). Registration may conceptually involve testing a plurality of coordinate transformations and scaling values to find a correlation that has a sufficiently high correlation or confidence factor. Once a correlation is found with the sufficiently high confidence factor, the bone model is said to be registered to the location of the bone fiducial. Thereafter, the example registration method 300 may end (block 318); however, the surgical controller 118 may then use the registered bone model to provide computer-assisted navigation regarding a procedure involving the bone.

In the examples discussed to this point, registration of the bone model involves a touch-based registration technique using the probe 124 without a carried fiducial. However, other registration techniques are possible, such as a touchless registration technique. The example touchless registration technique again relies on placement of the bone fiducial 128. As before, when the viewing direction of the arthroscope 108 is relatively constant, the bone fiducial may have fewer faces with respective fiducials. Once placed, the bone fiducial 128 represents a fixed location on the outer surface of the bone in the view of the arthroscope 108, even as the position of the arthroscope 108 is moved and changed relative to the bone fiducial 128. Again, in order to relate or register the bone visible in the video images to the three-dimensional bone model, the surgical controller 118 (FIG. 1) determines a plurality of surface features of an outer surface of the bone, and in this example determining the plurality of surface features is based on a touchless registration technique in which the surface features are identified based on motion of the arthroscope 108 and camera 110 relative to the bone fiducial 128.

Another technique for registering the bone model to the bone uses a patient-specific instrument. In both touch-based and touchless registration techniques, a registration model is created, and the registration model is used to register the bone model to the bone visible in the video images. Conceptually, the registration model is used to determine a coordinate transformation and scaling to align the bone model to the actual bone. However, if the orientation of the bone in the video images is known or can be determined, use of the registration model may be omitted, and instead the coordinate transformations and scaling may be calculated directly.

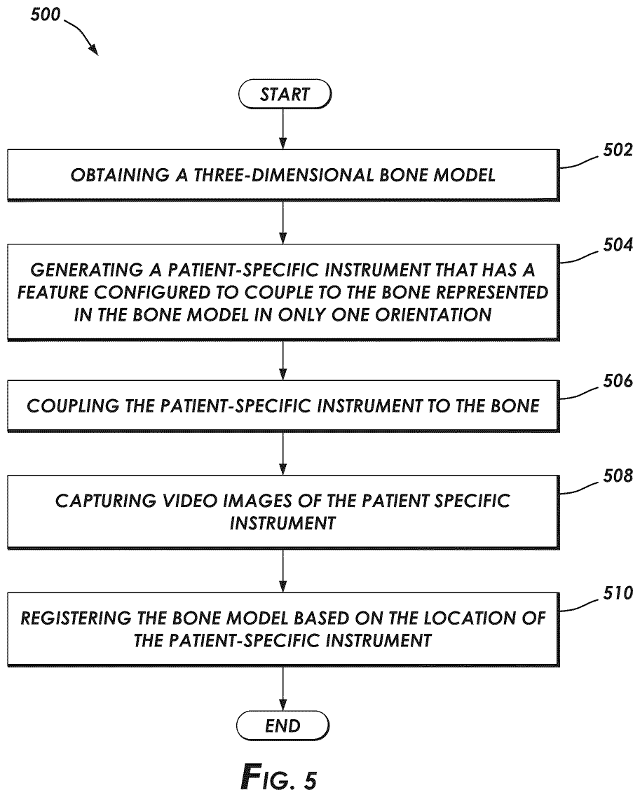

FIG. 5 shows a method 500 in accordance with at least some embodiments. The example method may be implemented in software within one or more computer systems, such as, in part, the surgical controller 118. In particular, the example method 500 comprises obtaining a three-dimensional bone model (block 502). In the patient-specific instrument registration technique, what is obtained is the three-dimensional bone model that may be created by segmenting a plurality of non-invasive images (e.g., MRI) taken preoperatively or intraoperatively.

The method 500 further includes generating a patient-specific instrument that has a feature designed to couple to the bone represented in the bone model in only one orientation (block 504). Generating the patient-specific instrument may first involve selecting a location at which the patient-specific instrument will attach. For example, a device or computer system may analyze the bone model and select the attachment location. In various examples, the attachment location may be a unique location in the sense that, if a patient-specific instrument is made to couple to the unique location, the patient-specific instrument will not couple to the bone at any other location. In the example case of an anterior cruciate ligament repair, the location selected may be at or near the upper or superior portion on the intercondylar notch. If the bone model shows another location with a unique feature, such as a bone spur or other raised or sunken surface anomaly, such a unique location may be selected as the attachment location for the patient-specific instrument. For example, for hip procedures, the location may be selected based on a location, within the hip joint, of a bone spur or other anatomical feature associated with the hip procedure.

Moreover, forming the patient-specific instrument may take any suitable form. In one example, a device or computer system may directly print, such as using a 3D printer, the patient-specific instrument. In other cases, the device or computer system may print a model of the attachment location, and the model may then become the mold for creating the patient-specific instrument. For example, the model may be the mold for an injection-molded plastic or casting technique. In some examples, the patient-specific instrument carries one or more fiducials, but as mentioned above, in other cases the patient-specific instrument may itself be tracked and thus carry no fiducials.

The method 500 further includes coupling the patient-specific instrument to the bone, in some cases the patient-specific instrument having the fiducial coupled to an exterior surface (block 506). As described above, the attachment location for the patient-specific instrument can be selected to be unique such that the patient-specific instrument couples to the bone in only one location and in only one orientation. In the example case of an arthroscopic procedure, the patient-specific instrument may be inserted arthroscopically. That is, the attachment location may be selected such that a physical size of the patient-specific instrument enables insertion through the ports in the patient's skin. In other cases, the patient-specific instrument may be made or constructed of a flexible material that enables the patient-specific instrument to deform for insertion in the surgical site, yet return to the predetermined shape for coupling to the attachment location. However, in open procedures where the skin is cut and pulled away, exposing the bone to the open air, the patient-specific instrument may be a rigid device with fewer size restrictions.

The method 500 further includes capturing video images of the patient-specific instrument (block 508). Here again, the capturing may be performed intraoperatively. In the example case of an arthroscopic anterior cruciate ligament repair, the capturing of video images is by the surgical controller 118 by way of arthroscope 108 and camera 110. However, in open procedures where the skin is cut and pulled away, exposing the bone to the open air, the capturing may be by any suitable camera device, such as one or both cameras of a stereoscopic camera systems, or a portable computing device, such as a tablet or smart-phone device. In such cases, the video images may be provided to the surgical controller 118 in any suitable form.

The example method 500 further includes registering the bone model based on the location of the patient-specific instrument (block 510). That is, given that the patient-specific instrument couples to the bone at only one location and in only one orientation, the location and orientation of the patient-specific instrument is directly related to the location and origination of the bone, and thus the coordinate transformations and scaling for the registration may be calculated directly. Thereafter, the example method 500 may end; however, the surgical controller 118 may then use the registered bone model to provide computer-assisted navigation regarding a surgical task or surgical procedure involving the bone.

For example, with the registered bone model the surgical controller 118 may provide guidance regarding a surgical task of a surgical procedure. The specific guidance is dependent upon the surgical procedure being performed and the stage of the surgical procedure. A non-exhaustive list of guidance comprises: changing a drill path entry point; changing a drill path exit point; aligning an aimer along a planned drill path; showing location at which to cut and/or resect the bone; reaming the bone by a certain depth along a certain direction; placing a device (suture, anchor or other) at a certain location; placing a suture at a certain location; placing an anchor at a certain location; showing regions of the bone to touch and/or avoid; and identifying regions and/or landmarks of the anatomy. In yet still other cases, the guidance may include highlighting within a version of the video images displayed on a display device, which can be the arthroscopic display or a see-through display, or by communicating to a virtual reality device or a robotic tool.

Visual markers (such as the bone fiducial 128) attached to the anatomies define reference frames to which a pre-operative model and intra-operative acquired data are aligned. After fixation, motion or movement of these visual markers may occur when arthroscopes, endoscopes, or surgical instruments collide with the visual markers. Marker motion after the registration process may cause a misalignment of the anatomies with the pre-operative model and previously acquired data and therefore may compromise the surgical navigation by providing incorrect guidance and support to the surgeon. Accordingly, detection of motion of the visual markers after the registration process is critical. However, conventional techniques for detecting motion do not perform view synthesis (e.g., generating synthetic images using a scene representation of a real image and positions of visual markers in an image feed), perform image similarity analysis on the real and synthetic/synthesized images, or use NeRF techniques as described below in more detail.

Marker movement detection systems and methods according to the present disclosure are configured to automatically detect movement of visual markers fixed to anatomic surfaces using synthetic view synthesis techniques by acquiring a sparse or dense set of images of the surgical environment including the visual markers. The images are used to generate a scene representation (e.g., a scene representation of a “real” image), enabling the creation of synthetic images from positions of the visual markers. In some examples, scene representation algorithms necessitate images alongside their corresponding camera poses. These poses are determined concerning a specific visual marker. Consequently, if the marker shifts, the camera pose will change, even if the camera remains stationary. The scene representations assume camera poses relative to a fixed visual marker position. If the position of the marker shifts, the scene representation will fail to produce synthetic views resembling those captured when the visual marker location has changed.

As used herein, a “scene representation” includes a description of features and components in a real-world image. The scene representation may include, but is not limited to, descriptions of objects and object attributes (e.g., size, color, shape, etc.), relationships between objects and/or the environment (e.g., position, orientation, distances, etc.), lighting, etc. Information in the scene representation may be organized as scene graphs, depth maps, semantic segmentation maps, mesh representations, point clouds, and so on. In one example, the scene representation may include NeRF elements representing the scene as a continuous volumetric function.

Subsequent to generating the scene representation, for each new visual marker location in an image feed, a new synthetic/synthesized image is generated. If the new visual marker location is consistent with marker location used during the computation of the scene representation (e.g., as indicated by an image similarity calculation or algorithm), then the real and synthetic/synthesized images should be similar. Conversely, if the visual marker moved subsequent to the generation of the scene representation, then the synthesized image will differ from the real image.

Metrics can then be calculated to analyze the similarity between the real and synthesized views and automatically detected marker motion/movement. For example, a high similarity or similarity score may indicate minimal or no marker movement (or a low likelihood of movement) while a low similarity or similarity score may indicate that the marker moved (or a high likelihood of movement).

As one example, neural radiance field (NeRF) techniques can be used to generate the synthesized images. NeRF techniques provide a deep learning framework for view synthesis that uses Multilayer Perceptrons (MLPs) for encoding a 3D environment. NeRF techniques allow new views to be synthesized by directly optimizing parameters of a continuous 5D representation to minimize the error of rendering/synthesizing a set of input images. For example, to develop a NeRF model, images and the corresponding camera poses are required during the training process, which can be obtained from the visual markers using surgical navigation and registration techniques described above.

As one example, deep learning development may include a training phase, a validation phase, and a testing phase. Accordingly, every dataset used for development and implementation of a deep learning or other machine learning model can be categorized as a training dataset (a sample of data that is used to train the model), a validation dataset (a sample of data used to provide an unbiased evaluation on model fit during the training phase while tuning model hyperparameters; the model does not “learn” from the validation set, but the validation set is used to tune hyperparameters and therefore indirectly affects the model), or a test dataset (a sample of data that is used for evaluating the final model after the training phase).

For a model implemented in accordance with the principles of the present disclosure, the training data may correspond to images in which the location of the marker is the same as the location of the marker during the registration process (and/or another condition or event that defines a correct location of the visual markers with respect to patient anatomy).

Conversely, image similarity can be calculated using various methods and/or metrics. For example, photometric errors can be used for quantitative comparisons purposes. As one example, a Peak Signal-to-Noise Ratio (PSNR) is a quantitative measurement of similarity between an original image (the ground-truth) and a corresponding rendered (synthetic) image. The higher the PSNR, the greater the similarity of the rendered image to the original image. As one example, PSNR can be calculated in accordance with:

$$PSNR = - 10 {log}_{10} ( MSE ) ; and$$

$$MSE = \frac{{{\sum }_{M , N} [ {I}_{1} ( m , n ) - {I}_{2} ( m , n ) ]}^{2}}{M \times N} ,$$

where I₁ and I₂ represent the original (e.g., a real arthroscopic) image and the rendered/synthesized image, respectively, M represents an image height, and N represents an image width.

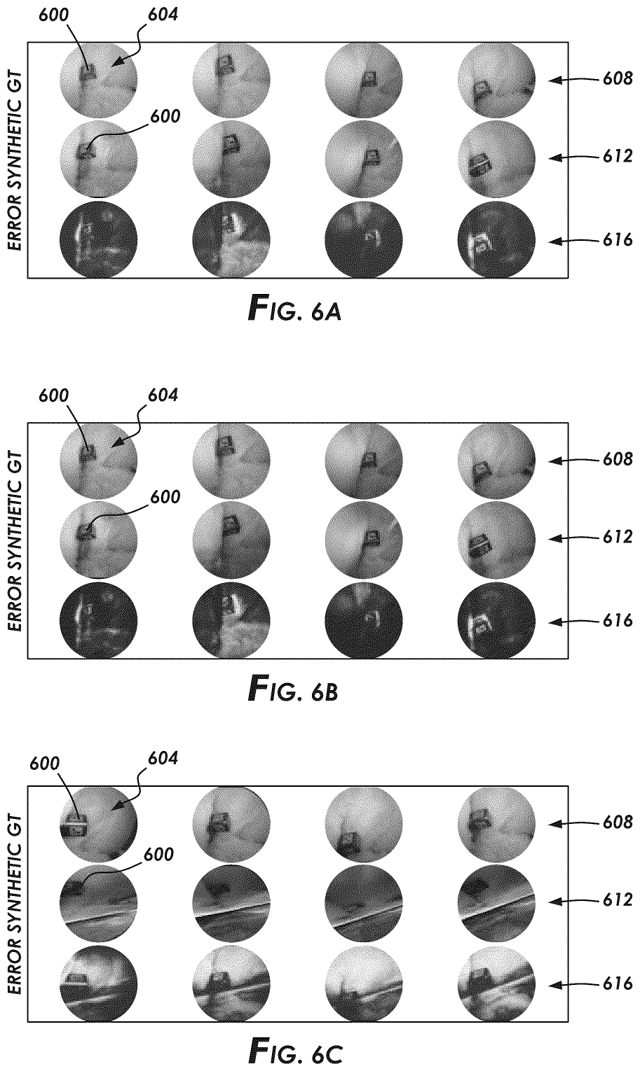

FIGS. 6A, 6B, and 6C illustrate results of example marker motion techniques according to the principles of the present disclosure. In these examples, a base marker 600 is fixed to a patient anatomy, such as a femur 604. Subsequent to training a model (e.g., a NeRF model) configured to generate synthetic views/images, marker movement systems and methods according to the present disclosure are used to evaluate whether the marker 600 moved relative to the original position provided to the model.

Accordingly, FIGS. 6A, 6B, and 6C show qualitative comparisons of real (e.g., ground-truth, or GT) images (presented in a row as shown at 608) with synthetic images generated by a trained (e.g., NeRF) model (presented in a row as shown at 612), and a resulting error (presented in a row as shown at 616). FIG. 6A illustrates a scenario where no visible motion of the marker 600 was detected. FIG. 6B illustrates a scenario where a small amount of visible motion of the marker 600 was detected (e.g., a nonzero amount of motion, but less than a threshold amount of motion, which may be referred to as a detection threshold). FIG. 6C illustrates a scenario where a large amount of visible motion of the marker 600 was detected (e.g., an amount of motion greater than or equal to the detection threshold).

As shown in FIG. 6A, the location of the marker 600 (in the row 608) is the same as the location of the marker 600 used during training of the model (as shown in the row 612), resulting in a high image similarity. Images shown in the row 616 indicate per-pixel errors (e.g., using varying colors, contrast, brightness, etc.). For example, high uniformity of color/shading in the images in the row 616 may indicate no error (high image similarity) while low uniformity and high variance may indicate high error (low image similarity). In an example, dark blue may indicate no error while red indicates high error, with various transitions between the colors as error increases (e.g., from dark blue to light blue, green, yellow, and red).

As shown in FIG. 6B, the location of the marker 600 in the row 608 is slightly different with respect to the location of the marker 600 in the row 612. Accordingly, image similarity decreases slightly and error correspondingly increases as indicated by the images in the row 616.

As shown in FIG. 6C, the location of the marker 600 in the row 608 is significantly different with respect to the location of the marker 600 in the row 612. Accordingly, image similarity decreases significantly and error correspondingly increases as indicated by the images in the row 616.

Accordingly, as shown in the per-pixel error rows 616 in each of the FIGS. 6A, 6B, and 6C, per-pixel error increases as degree or amount of movement of the marker 600 in the synthesized images increases relative to the GT images.

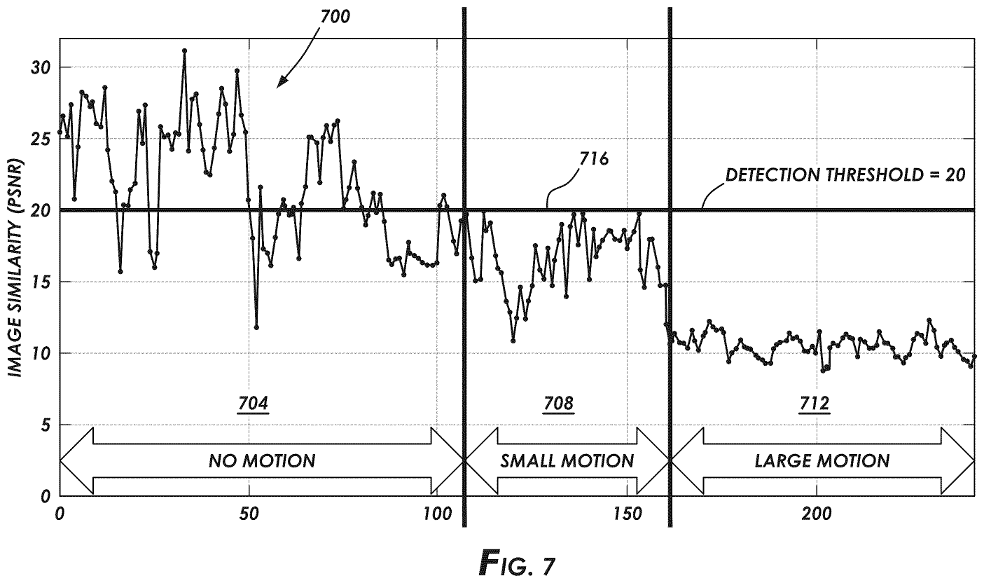

FIG. 7 shows example image similarity metrics (e.g., image similarity scores 700, shown as PSNR values) according to the principles of the present disclosure. The scores 700 correspond to comparisons between “real” (e.g., original arthroscopic) images and synthetic images generated using NeRF techniques as described herein. The x-axis identifies a time instant of a particular image while the y-axis is the image similarity score. For illustration purposes, the scores 700 are shown for a “no motion” comparison region 704, a “small motion” comparison region 708, and a “large motion” comparison region 712. The no motion comparison region 704 corresponds to a comparison between GT and synthesized images with the marker 600 in a same position/location (e.g., a comparison where the marker 600 did not experience any motion with respect to the pose captured during registration). The “small motion” comparison region 708 corresponds to a comparison between GT and synthesized images with the marker 600 in a slightly different position/location (e.g., a comparison where the marker 600 experienced a small amount of motion with respect to the pose captured during registration). The “large motion” comparison region 712 corresponds to a comparison between GT and synthesized images with the marker 600 in a significantly different position/location (e.g., a comparison where the marker 600 experienced a large amount of motion with respect to the pose captured during registration). Accordingly, the image similarity scores 700 are generally lower when the marker 600 moved. Further, the larger/greater the motion, the lower the similarity scores 700.

The scores 700 indicate clear degradation of the similarity values when marker motion occurs. In this example, a detection threshold 716 of PSNR =20 is used, but other detection threshold values may be used. In other words, a score (e.g., a PSNR) for a given image comparison that is greater than or equal to the detection threshold 716 indicates no movement of the marker 600 while a score less than the detection threshold 716 indicates at least some movement of the marker 600. Although the no motion comparison region 704 includes some outliers where the similarity score 700 is below the detection threshold 716, these outliers can be discarded or disregarded in accordance with various filtering techniques, such as smoothing techniques, outlier rejection filtering techniques, mean or median filtering, etc.

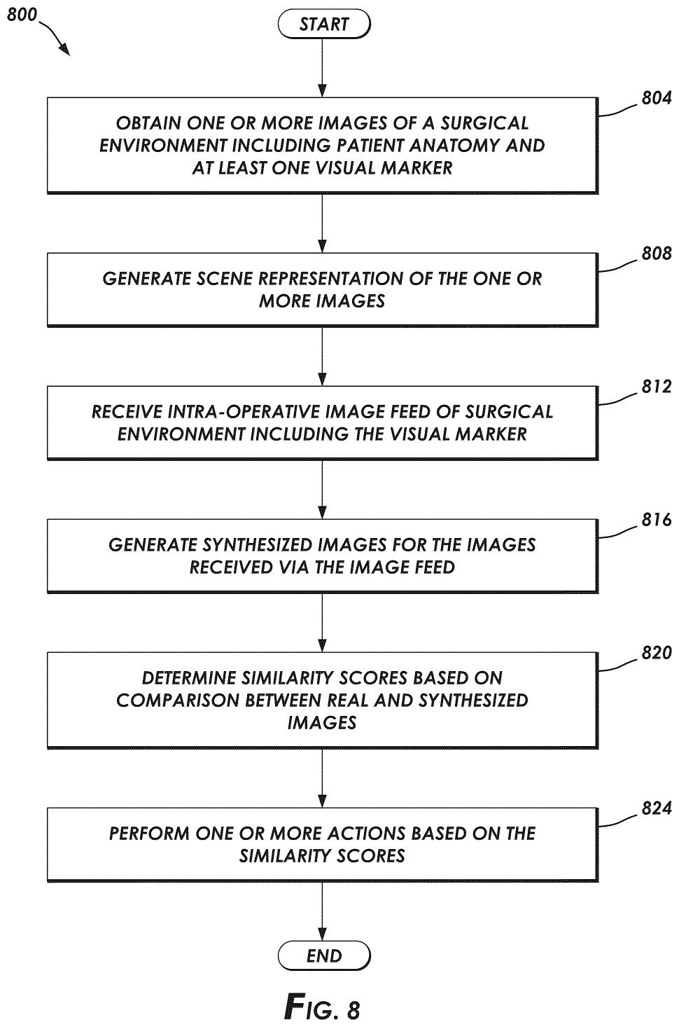

FIG. 8 shows an example method 800 for performing movement detection in accordance with the principles of the present disclosure. As described, the method 800 may be performed by one or more processing devices or processors, computing devices, etc., such as the system 100 or another computing device executing instructions stored in memory. One or more steps of the method 800 may be omitted in various examples, and/or may be performed in a different sequence than shown in FIG. 8. The steps may be performed sequentially or non-sequentially, two or more steps may be performed concurrently, etc.

At 804, the method 800 includes obtaining “real” images of a surgical environment including patient anatomy with one or more visual markers (e.g., bone fiducial markers) fixed to patient anatomy. Obtaining the images may include obtaining images using an arthroscope or other imaging device. In some examples, obtaining the images may include performing an image scan of patient anatomy, such as by performing a pre-operative imaging scan (e.g., a CT scan), retrieving the stored image scan (as data) from memory, etc. In other examples, other imaging techniques may be used. The obtained images may include a sparse or dense set of images of the surgical environment including the one or more visual markers (e.g., at least one visual marker).

At 808, the method 800 includes generating a scene representation of one or more of the “real” images. For example, the scene representation is generated using NeRF techniques as described herein (e.g., one or more computing devices, processors or processing devices, etc. configured to implement/execute a NeRF model trained to generate a scene representation of a surgical environment including one or more visual markers). The NeRF model generates the scene representation of the one or more images as a continuous volumetric function (e.g., a function describing radiance and density of points in a 3D space corresponding to the environment captured by the image). The NeRF model may include, implement, and/or be implemented by deep learning neural network.

As one example, the NeRF model receives a set of the real images of the surgical environment (e.g., images taken from multiple viewpoints/perspectives, as represented by the images in the row 608) and corresponding camera pose and learns/generates the scene representation (e.g., using a neural network, such as a multilayer perceptron). Inputs to the neural network may include 3D coordinates of each point in a space represented by the images (in an x, y, z coordinate space) and a 2D viewing direction (corresponding to the camera pose). Outputs from the neural network may include volume densities representing the opacity of each point and colors representing an emitted radiance of each point.

At 812, the method 800 includes receiving one or more images (e.g., an image feed) of the surgical environment (e.g., real-time or near real-time images), such as an intra-operative image feed provided by an arthroscope or other imaging device. The images include the one or visual markers and, accordingly, show any potential movement/motion (e.g., a change of location within the surgical environment) of the visual markers. The images may be provided and analyzed continuously or semi-continuously (e.g., at a desired sampling rate).

At 816, the method 800 includes generating synthetic/synthesized images for the images received via the image feed. The synthesized images include respective new visual marker locations as shown in the image feed. As one example, the synthesized images generated at 816 may correspond to the images shown in the row 612.

In an example, generating the synthesized images includes generating, using NeRF techniques, the synthesized images using images included in the image feed and the scene representation generated at 812. For example, the synthesized images are generated using NeRF volume rendering techniques. NeRF volume rendering techniques may include tracing a ray from the camera/imaging device (e.g., based on camera pose) through each pixel into the scene sampling points along the ray, obtaining a density and color of each sampled point, and combining density and color values (e.g., using volume rendering functions) to determine a final color of each pixel).

At 820, the method 800 includes determining similarity scores or values based on a comparison between the real images and the synthesized images. As one example, the similarity scores includes PSNR scores as described herein. Determining the similarity scores may include generating one or more error images visually representing differences/similarities between the real and synthesized images (e.g., such as the images shown in the row 616).

At 824, the method 800 includes performing one or more actions based on the similarity scores. As one example, one or more actions may be performed in response to the similarity scores exceeding (or decreasing below) a detection threshold as described above in FIG. 7. The one or more actions may include, but are not limited to, generating an alert or other notification (such as a video or audio alert), generating visual guidance on a display including the intra-operative image feed, etc. In examples, the one or more actions may include updating a stored/known location of the one or more visual markers and modifying control, visual guidance, parameters, etc. of the surgical procedure based on the updated location. For example, during the surgical procedure, guidance, notifications, etc. may be provided to the surgeon based on locations of instruments relative to the visual markers. Accordingly, updating the locations of the visual markers increases the accuracy of subsequent guidance. In an example, updating the locations includes correcting an alignment between the image feed and one or more elements of visual guidance, such as an AR overlay.

Although described with respect to detecting movement of visual makers, such as fiducial markers, within a surgical environment, the principles of the present disclosure may also be implemented to detect movement of other objects relative to one another within the surgical environment, including, but not limited to, anatomical structures (e.g., relative to one another and/or to another object or reference point) and surgical instruments. In some examples, the principles of the present disclosure may be implemented to detect various other changes in the surgical environment (e.g., changing amounts of fluid, such as blood, saline, etc., in the surgical environment, presence or absence of objects or features, etc.). For example, as described herein, synthesized images of the surgical environment may be generated and compared to original or subsequent images to determine similarity scores and changes may be detected based on the similarity scores. In examples where objects do not include a visual AR tag, object pose estimation techniques can be used for calculating the pose and training the NeRF model.

In various examples, any scene representation technique for generating synthetic images can be used with the principles of the present disclosure, such as neural representation models, light field sampling techniques, mesh-based representation techniques, differentiable rasterizers, etc. Similarly, any suitable image similarity calculation, metric, or score can be used. Although described herein with respect to PSNR scores, image metrics such as Structural Similarity (SSIM), Learned Perceptual Image Patch Similarity (LPIPS), Normalized Cross Correlation (NCC), and other learning- and non-learning-based distance inference approaches can be used.

Although described with respect to visual markers attached to the femur for ACL navigation, the principles of the present disclosure may be implemented for any type of procedure and/or anatomy requiring video-based navigation.

Accordingly, movement detection systems and methods according to the present disclosure do not require generation and application of an augmented reality overlay to an intra-operative video, and do not require user intervention. Since the techniques described herein are implemented automatically, efficiency and clinical workflow are improved and human error is minimized. The intra-operative image/video feed is continuously evaluated and warnings can be provided in real-time. Further, there is no need to continuously inspect the video and augmented reality functionality, thereby reducing costs

In some examples, the principles of the present disclosure can be used to correct the camera pose extracted from the visual markers after detection of movement/motion. By optimizing the image similarity of a target image and the pose used for extracting a synthetic view from the scene representation (e.g., a synthetic view provided using NeRF techniques), a corrected pose corresponding to the visual marker motion can be inferred. This corrected pose can be used, for example, to re-align the 3D model for AR.

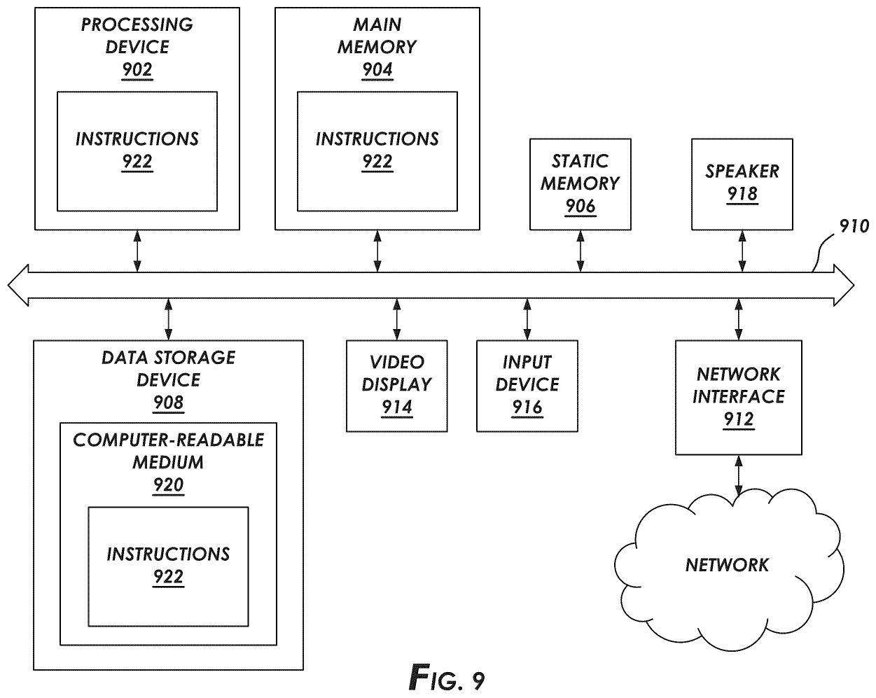

FIG. 9 shows an example computer system or computing device 900 configured to implement the various systems and methods of the present disclosure. In one example, the computer system 900 may correspond to one or more computing devices of the system 100, the surgical controller 118, a device that creates a patient-specific instrument, a tablet device within the surgical room, the controller 812, or any other system that implements any or all the various methods discussed in this specification. For example, the computer system 900 may be configured to implement all or portions of the method 900. The computer system 900 may be connected (e.g., networked) to other computer systems in a local-area network (LAN), an intranet, and/or an extranet (e.g., device cart 102 network), or at certain times the Internet (e.g., when not in use in a surgical procedure). The computer system 900 may be a server, a personal computer (PC), a tablet computer or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 900 includes a processing device 902, a main memory 904 (e.g., read-only memory (ROM), flash memory, dynamic random access memory (DRAM) such as synchronous DRAM (SDRAM)), a static memory 906 (e.g., flash memory, static random access memory (SRAM)), and a data storage device 908, which communicate with each other via a bus 910.

Processing device 902 represents one or more general-purpose processing devices such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also be one or more special-purpose processing devices such as an application specific integrated circuit (ASIC), a field programmable gate array (FPGA), a digital signal processor (DSP), network processor, or the like. The processing device 902 is configured to execute instructions for performing any of the operations and steps discussed herein. Once programmed with specific instructions, the processing device 902, and thus the entire computer system 900, becomes a special-purpose device, such as the surgical controller 118.

The computer system 900 may further include a network interface device 912 for communicating with any suitable network (e.g., the device cart 102 network). The computer system 900 also may include a video display 914 (e.g., the display device 114), one or more input devices 916 (e.g., a microphone, a keyboard, and/or a mouse), and one or more speakers 918. In one illustrative example, the video display 914 and the input device(s) 916 may be combined into a single component or device (e.g., an LCD touch screen).

The data storage device 908 may include a computer-readable storage medium 920 on which the instructions 922 (e.g., implementing any methods and any functions performed by any device and/or component depicted described herein) embodying any one or more of the methodologies or functions described herein is stored. The instructions 922 may also reside, completely or at least partially, within the main memory 904 and/or within the processing device 902 during execution thereof by the computer system 900. As such, the main memory 904 and the processing device 902 also constitute computer-readable media. In certain cases, the instructions 922 may further be transmitted or received over a network via the network interface device 912.

While the computer-readable storage medium 920 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. A movement detection system for a surgical procedure performed in a surgical environment, the movement detection system comprising:
memory storing instructions; and
one or more processing devices configured to execute the instructions, wherein executing the instructions causes the movement detection system to
receive first data corresponding to one or more images of the surgical environment, wherein the one or more images include at least one visual marker located within the surgical environment,
using the first data, generate a scene representation corresponding to the one or more images,
generate, based on the scene representation and a location of the at least one visual marker in an image feed of the surgical environment, a synthesized image of the surgical environment,
calculate an image similarity score indicating a similarity between the synthesized image and the one or more images, and
perform one or more actions based on the image similarity score.

2. The movement detection system of claim 1, wherein generating the synthesized image includes generating a plurality of synthesized images corresponding to a plurality of locations of the at least one visual marker.

3. The movement detection system of claim 1, wherein generating the synthesized image includes using, to generate the synthesized imaged, at least one of:
a neural radiance field (NeRF) model;
neutral representation modeling;
light field sampling;
mesh-based representation;
a differentiable rasterizer; and
Gaussian splatting.

4. The movement detection system of claim 1, wherein calculating the image similarity score includes calculating a peak signal-to-noise ratio based on a comparison between the synthesized image and the one or more images.

5. The movement detection system of claim 1, wherein performing the one or more actions includes correcting alignment data associated with the at least one visual marker based on the image similarity score.

6. The movement detection system of claim 1, wherein performing the one or more actions includes (i) determining whether the image similarity score is less than a detection threshold and (ii) performing the one or more actions in response to the image similarity score being less than the detection threshold.

7. The movement detection system of claim 6, wherein an image similarity score less than the detection threshold is indicative of movement of the at least one visual marker.

8. The movement detection system of claim 1, wherein the image feed includes intra-operative arthroscopic images.

9. The movement detection system of claim 1, wherein the at least one visual marker includes a fiducial marker fixed to patient anatomy.

10. The movement detection system of claim 1, wherein (i) generating the scene representation includes generating the scene using a neural radiance field (NeRF) model and (ii) generating the synthesized image includes generating the synthesized image using the NeRF model.

11. A method for detecting movement of at least one visual marker within a surgical environment, the method comprising, using one or more processing devices:
receiving first data corresponding to one or more images of the surgical environment, wherein the one or more images include at least one visual marker located within the surgical environment;
using the first data, generating a scene representation corresponding to the one or more images;
generating, based on the scene representation and a location of the at least one visual marker in an image feed of the surgical environment, a synthesized image of the surgical environment;
calculating an image similarity score indicating a similarity between the synthesized image and the one or more images; and
performing one or more actions based on the image similarity score.

12. The method of claim 11, wherein generating the synthesized image includes generating a plurality of synthesized images corresponding to a plurality of locations of the at least one visual marker.

13. The method of claim 11, wherein generating the synthesized image includes using, to generate the synthesized image, at least one of:
a neural radiance field (NeRF) model;
neutral representation modeling;
light field sampling;
mesh-based representation;
a differentiable rasterizer; and
Gaussian splatting.

14. The method of claim 11, wherein calculating the image similarity score includes calculating a peak signal-to-noise ratio based on a comparison between the synthesized image and the one or more images.

15. The method of claim 11, wherein performing the one or more actions includes correcting alignment data associated with the at least one visual marker based on the image similarity score.

16. The method of claim 11, wherein performing the one or more actions includes (i) determining whether the image similarity score is less than a detection threshold and (ii) performing the one or more actions in response to the image similarity score being less than the detection threshold.

17. The method of claim 16, wherein an image similarity score less than the detection threshold is indicative of movement of the at least one visual marker.

18. The method of claim 11, wherein the image feed includes intra-operative arthroscopic images.

19. The method of claim 11, wherein the at least one visual marker includes a fiducial marker fixed to patient anatomy.

20. The method of claim 11, wherein (i) generating the scene representation includes generating the scene using a neural radiance field (NeRF) model and (ii) generating the synthesized image includes generating the synthesized image using the NeRF model.
